(19) United States
(12) Patent Application Publication
(10) Pub. No.: US 2014/0304658 A1
(43) Pub. Date: Oct. 9, 2014

(54) METHOD OF AND SYSTEM FOR PRESENTING IMAGE INFORMATION TO A USER OF A CLIENT DEVICE

(71) Applicant: Yandex Europe AG, Luzern (CH)

(72) Inventors: Anastasia Petrovna LARKINA, Kaluga (RU); Liya Sergeevna KAREPOVA, Moscow (RU); Sergey Alexandrovich BEREZHNOY, Rostov-na-Donu (RU); Roman Antonovich VORONEZHSKIY, Moscow (RU)

(73) Assignee: YANDEX EUROPE AG, Luzern (CH)

(21) Appl. No.: 13/956,994

(22) Filed: Aug. 1, 2013

Related U.S. Application Data
(63) Continuation of application No. 13/987,295, filed on Apr. 4, 2013, now abandoned.

(51) Int. Cl. G06F 3/0484; G06F 3/0481

(52) U.S. Cl. CPC G06F 3/04842; G06F 3/04817
USPC 715/838

(57) ABSTRACT

Method of and system for presenting image information to a user of a client device: Receiving, from the user via a user interface of the client device, a search query. Sending the search query to a server. Receiving, from the server, search results in respect of the search query, the search results including a plurality of images. Displaying, via the user interface, a search engine results page (SERP) including the plurality of the images in a thumbnail array. Receiving, a user interface, an indication of a selection by the user of one of the plurality of the images in the thumbnail array. Changing a display of the plurality of the images in a thumbnail array via the user interface to include a display of an expanded version of the one of the plurality of images in the thumbnail array having been selected by the user, without leaving the SERP.

### CROSS-REFERENCE

The present application is a continuation of U.S. patent application Ser. No. ______ (originally 61/808,299), filed Apr. 4, 2013, entitled “Method of and System for Presenting Image Information to a User of a Client Device”, the contents of which are incorporated herein by reference in their entirety.

### FIELD

The present invention relates to methods of and system for presenting image information to a user of a client device.

### BACKGROUND

The Internet provides access to a wide variety of resources, for example, video files, image files, audio files, or Web pages, including content for particular subjects, book articles, or news articles. A search engine can select one or more resources in response to receiving a search query. A search query is data that a user submits to (or causes, knowingly or unknowingly, to be submitted to or obtained by) a search engine to conduct a search to satisfy the user's informational needs. Search queries almost always include data in the form of text—e.g., one or more search query terms—as well as other information. The search engine selects and scores resources based on their relevance to the search query and on their importance relative to other resources to provide search results that link to the selected resources. The search results are typically ordered according to the scores and presented according to this order on what is known in the art as “search engine results page” (SERP).

Images are typically part of the search results and are presented on the SERP. Conventionally images being part of the search results are presented as a block in thumbnail format in an array on the SERP. In such an array the images may be presented as a series of thumbnails in defined rows (with no defined columns), a series of thumbnails in defined columns (with no defined rows), or a series of thumbnails in defined columns and rows. If the user desires to navigate to the Internet resource on a particular image shown in the thumbnail format in the image array is located, he or she will select the image (e.g. by “clicking” on the image). The thumbnail of the image is typically associated with a hyperlink to the Internet resource and thus the user will be redirected to the resource itself (e.g. a webpage containing the image from which the thumbnail was taken will open, displaying the image (and any other information on that page)).

Although the aforementioned conventional method for locating images available on the Internet is adequate, improvements are nonetheless desirable.

### SUMMARY

One drawback of conventional technology is that a lot of actions on the part of a user are required to peruse a number of different images presented in the search results in order to locate a particular image. In this respect, a user must select an image, navigate to the specific Internet resource on which that particular image is located, determine whether or not that is a particular image that the user is seeking, and if not, return to the SERP and restart the entire process with a different image. This can be a lot of “back and forth” on the part of the user if several images are required to be viewed by the user before he or she locates an appropriate one.

It is therefore an object of the present technology to ameliorate at least one inconvenience in (at least some) conventional technology, be it that described above or otherwise.

Thus, in implementations of the present technology, when a user selects a thumbnail image on the SERP, rather than being redirected to the specific Internet resource on which the original image is located, the display of the images in the SERP is changed and the user is presented with an expanded version of the selected image thumbnail on the SERP. If, upon viewing the expanded image, the user determines that the image is one that he or she is seeking, then the user can take an appropriate action (e.g. clicking on the expanded image) to be redirected to the specific Internet resource on which the original image is located. (In the present context, “redirected to a specific Internet resource”, could be, for example, navigating to a web page on which the image in question would be displayed (whether that web page would be displayed in the then current browser tab/window, in a new tab in the same browser window, or in a new browser window).) However, if, upon view the expanded image, the user determines that the image is not one that he or she is seeking, then the user can take an appropriate action (e.g. clicking a “close window element”) to close the display of the expanded image (and likely return the display of the array of image thumbnails to its prior state) or to cause an expanded image of a different thumbnail image to be presented in place of the one then currently being displayed (e.g. by selected a different one of the thumbnail images—e.g. by clicking on the different one of the thumbnail images). The user can continue in this manner indefinitely until a particular image (or images) that they are seeking is located. In this manner, the actions required on the part of the user to locate a particular image that they are seeking are reduced with respect to the conventional prior art described hereinabove.

Therefore, in one aspect, implementations of the present technology provide a method of presenting image information to a user of a client device, comprising: Receiving, from the user via a user interface of the client device, a search query. Sending, from the client device to at least one server via a communications network, the search query. Receiving, from the at least one server by the client device via the communications network, search results in respect of the search query, the search results including a plurality of images. Displaying, to the user via the user interface of the client device, a search engine results page (SERP) including at least some of the plurality of the images in a thumbnail array. Receiving, from the user via a user interface of the client device, an indication of a selection by the user of one of the plurality of the images in the thumbnail array. Changing a display of the at least some of the plurality of the images in the thumbnail array via the user interface of the client device to include a display of an expanded version of the one of the plurality of images in the thumbnail array having been selected by the user, without leaving the SERP.

In some implementations, changing a display of the at least some of the plurality of the images in the thumbnail array via the user interface of the client device to include a display of an expanded version of the one of the plurality of images in the thumbnail array having been selected by the user, without leaving the SERP is, expanding the array to create a new row in between existing rows of the images in the array and displaying in the new row an expanded version of the one of the plurality of images in the thumbnail array having been selected by the user.

In some implementations, changing a display of the at least some of the plurality of the images in the thumbnail array via the user interface of the client device to include a display of an expanded version of the one of the plurality of images in the thumbnail array having been selected by the user, without leaving the SERP is, displaying an expanded version of the one of the plurality of images in the thumbnail array having been selected by the user in a new row adjacent an existing top row of the array.

In some implementations, changing a display of the at least some of the plurality of the images in the thumbnail array via the user interface of the client device to include a display of an expanded version of the one of the plurality of images in the thumbnail array having been selected by the user, without leaving the SERP is, displaying an expanded version of the one of the plurality of images in the thumbnail array having been selected by the user in a row adjacent an existing bottom row of the array.

In some implementations, no other images are displayed in the new row.

In some implementations, at least one selected from a group consisting of an image size selector element, a zoom to full screen element, a show a next image element, a show a previous image element, a slideshow selector element, a title of the image, a description of the image, a link to a website in which the image appears, is displayed in the new row.

In another aspect, implementations of the present technology provide a method of providing image information for display to a user of a client device, comprising: Receiving, by at least one server from the client device via a communications network, a search query. Effecting, by the at least one server, a search in respect of the search query. Sending, by the at least one server to the client device via the communications network, search results, the search results including a plurality of images. Sending, by the at least one server to the client device via the communications network, instructions to cause a display to the user via the user interface of the client device of a search engine results page (SERP) including at least some of the plurality of the images in a thumbnail array. Sending, by the at least one server to the client device via the communications network, instructions to cause a change in the display of the at least some of the plurality of the images in a thumbnail array via the user interface of the client device to include a display of an expanded version of a one of the plurality of images in the thumbnail array having been selected by the user, without leaving the SERP.

In some implementations, the instructions to cause a change in the display of the at least some of the plurality of the images in the thumbnail array via the user interface of the client device to include a display of an expanded version of a one of the plurality of images in the thumbnail array having been selected by the user, without leaving the SERP are, instructions to cause a display of a new row in the array in between existing rows of the images in the array and a display in the new row of an expanded version of the one of the plurality of images in the thumbnail array having been selected by the user.

In some implementations, the instructions to cause a change in the display of the at least some of the plurality of the images in the thumbnail array via the user interface of the client device to include a display of an expanded version of a one of the plurality of images in the thumbnail array having been selected by the user, without leaving the SERP are, instructions to cause a display of a new row in the array adjacent an existing top row of the array and a display in the new row of an expanded version of the one of the plurality of images in the thumbnail array having been selected by the user.

In some implementations, the instructions to cause a change in the display of the at least some of the plurality of the images in a thumbnail array via the user interface of the client device to include a display of an expanded version of a one of the plurality of images in the thumbnail array having been selected by the user, without leaving the SERP are, instructions to cause a display of a new row in the array adjacent an existing bottom row of the array and a display in the new row of an expanded version of the one of the plurality of images in the thumbnail array having been selected by the user.

In some implementations, the instructions cause no other images to be displayed in the new row.

In some implementations, the instructions cause at least one selected from a group consisting of an image size selector element, a zoom to full screen element, a show a next image element, a show a previous image element, a slideshow selector element, a title of the image, a description of the image, a link to a website in which the image appears, to be displayed in the new row.

In another aspect, implementations of the present technology provide a system for presenting image information to a user of a client device, comprising: A search query reception component for receiving, from the user via a user interface of the client device, a search query. A search query dispatch component for sending, from the client device to at least one server via a communications network, the search query. A search results reception component for receiving, from the at least one server by the client device via the communications network, search results in respect of the search query, the search results including a plurality of images. A search result display component for displaying, to the user via the user interface of the client device, a search engine results page (SERP) including at least some of the plurality of the images in a thumbnail array. A user selection component for receiving, from the user via a user interface of the client device, an indication of a selection by the user of one of the plurality of the images in the thumbnail array. A search result display alteration component for changing a display of the at least some of the plurality of the images in a thumbnail array via the user interface of the client device to include a display of an expanded version of the one of the plurality of images in the thumbnail array having been selected by the user, without leaving the SERP.

In some implementations, the search result alteration component is for expanding the array to create a new row in between existing rows of the images in the array and displaying in the new row an expanded version of the one of the plurality of images in the thumbnail array having been selected by the user.

In some implementations, the search result alteration component is for expanding the array to create a new row adjacent an existing top row of the images in the array in between existing rows of the images in the array and displaying in the new row an expanded version of the one of the plurality of images in the thumbnail array having been selected by the user.

In some implementations, the search result alteration component is for expanding the array to create a new row adjacent an existing top row of the images in the array in between existing rows of the images in the array and displaying in the new row an expanded version of the one of the plurality of images in the thumbnail array having been selected by the user.

In some implementations, no other images are displayed in the new row.

In some implementations, at least one selected from a group consisting of an image size selector element, a zoom to full screen element, a show a next image element, a show a previous image element, a slideshow selector element, a title of the image, a description of the image, a link to a website in which the image appears, is displayed in the new row.

A system for providing image information for presentation to a user of a client device, comprising: A search query reception component for receiving, at least one server from the client device via a communications network, a search query. A search component for effecting, by the at least one server a search in respect of the search query. A search results dispatch component for sending, by the at least one server to the client device via the communications network, search results, the search results including a plurality of images. A search engine results page (SERP) dispatch component for sending, by the at least one server to the client device via the communications network, instructions to cause a display to the user via the user interface of the client device, a SERP including at least some of the plurality of the images in a thumbnail array. A SERP display alteration component for sending, by the at least one server to the client device via the communications network, instructions to cause a change in the display of the at least some of the plurality of the images in a thumbnail array via the user interface of the client device to include a display of an expanded version of a one of the plurality of images in the thumbnail array having been selected by the user, without leaving the SERP.

In some implementations, the SERP display alteration component is for causing a display of a new row in the array in between existing rows of the images in the array and a display in the new row of an expanded version of the one of the plurality of images in the thumbnail array having been selected by the user.

In some implementations, the instructions to cause a change in the display of the at least some of the plurality of the images in a thumbnail array via the user interface of the client device to include a display of an expanded version of a one of the plurality of images in the thumbnail array having been selected by the user, without leaving the SERP are, instructions to cause a display of a new row in the array adjacent an existing top row of the array and a display in the new row of an expanded version of the one of the plurality of images in the thumbnail array having been selected by the user.

In some implementations, the SERP display alteration component is for causing a display of a new row in the array adjacent an existing bottom row of the array and a display in the new row of an expanded version of the one of the plurality of images in the thumbnail array having been selected by the user.

In some implementations, the instructions cause no other images to be displayed in the new row.

In some implementations, the instructions cause at least one selected from a group consisting of an image size selector element, a zoom to full screen element, a show a next image element, a show a previous image element, a slideshow selector element, a title of the image, a description of the image, a link to a website in which the image appears, to be displayed in the new row.

In the context of the present specification, a “server” is a computer program that is running on appropriate hardware and is capable of receiving requests (from client devices) over a network, and carrying out those requests, or causing those requests to be carried out. The hardware may be one physical computer or one physical computer system, but neither is required to be the case with respect to the present technology. In the present context, the use of the expression “at least one server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “a client device” is any computer hardware that is capable of running software appropriate to the relevant task at hand. Thus, some (non-limiting) examples of client devices include personal computers (desktops, laptops, netbooks, etc.), smartphones, and tablets.

In the context of the present specification, a “database” is any structured collection of data, irrespective its particular structure, database management software, or computer hardware on which the data is stored, implemented or otherwise rendered available for use. A database is in “operational communication” in the present context when it is rendered available for use as part of a database management system that is itself connected to an accessible communications network.

In the context of the present specification, the expression “component” is meant include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of various implementations of the present technology will become apparent from the following description, the accompanying drawings and the appended claims.

### BRIEF DESCRIPTION OF THE DRAWINGS

For a better understanding of the present invention, as well as other aspects and further features thereof, reference is made to the following description which is to be used in conjunction with the accompanying drawings, where:

FIG. 1 shows a search engine results page (SERP) in respect of the search query “egg roll” having been performed by the Yandex™ search engine.

FIG. 2 shows the SERP of FIG. 1 the display of which has been modified to focus on the images being a part of the search results.

FIG. 3 shows the SERP of FIG. 2 the display of which has been modified to show an expanded image of one the images being part of the search results.

FIG. 4 shows the SERP of FIG. 2 the display of which has been modified to show an expanded image of the one the images being part of the search results.

### DETAILED DESCRIPTION

Referring to the figures, there are shown various views of a search engine results page (SERP) 21 illustrating implementations of the present technology. It is to be expressly understood that SERP 21 is merely one implementation of the present technology. The description thereof that follows is intended to be only a description of an illustrative example of the present technology. This description is not intended to define the scope or set forth the bounds of the present technology. In some cases, what are believed to be helpful examples of modifications to the SERP 21 may also be set forth hereinbelow. This is done merely as an aid to understanding, and, again, not to define the scope or set forth the bounds of the present technology. These modifications are not exhaustive list, and, as a person skilled in the art would understand, other modifications are likely possible. Further, it should not be interpreted that where this has not been done, i.e. where no examples of modifications have been set forth, that no modifications are possible and/or that what is described is the sole manner of implementing that element of the present. As a person skilled in the art would understand, this is likely not the case. In addition it is to be understood that SERP 21 provides a simple implementation of the present technology, which is presented in this manner as an aid to understanding. As persons skilled in the art would understand, some implementations of the present technology may be of a greater complexity.

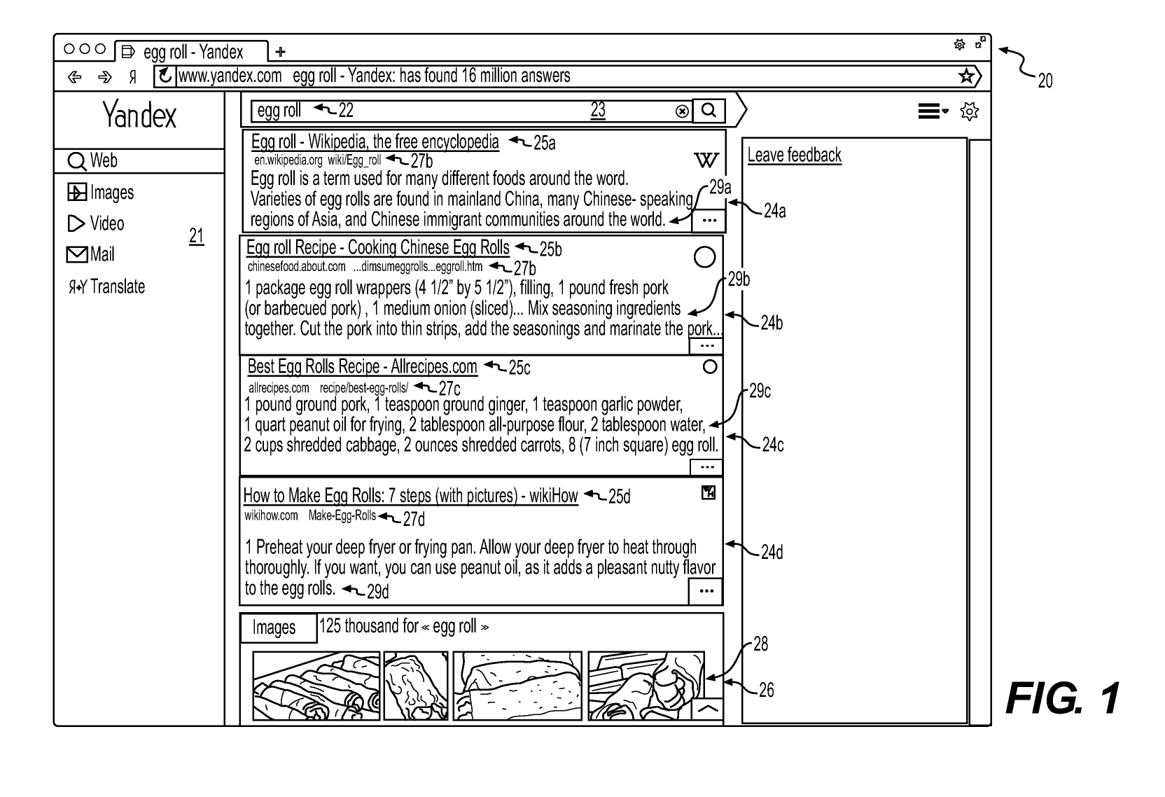

Referring to FIG. 1, there is a shown a web browser window 20. Shown in web browser window 20 is a SERP 21. The SERP 21 shows the results of a search in respect of the search term “egg roll” 22 having been performed by the Yandex™ search engine. On the SERP 22 the search term 22 is shown within the search bar 23. Below the search bar 23 are the results of the search. In respect of this search, results include four different webpages 24a, 24b, 24c, 24d. Each of the webpages 24a, 24b, 24c, 24d is shown in a block that includes the title of the webpage 25a, 25b, 25c, 25d; the URL of the webpage 27a, 27b, 27c, 27d; and a portion of some text shown on the webpage 29a, 29b, 29c, 29d. Below the display of the information on the webpages 24a, 24b, 24c, 24d, is an array 28 of images 26 being part of the search results. The images 26 are in thumbnail format.

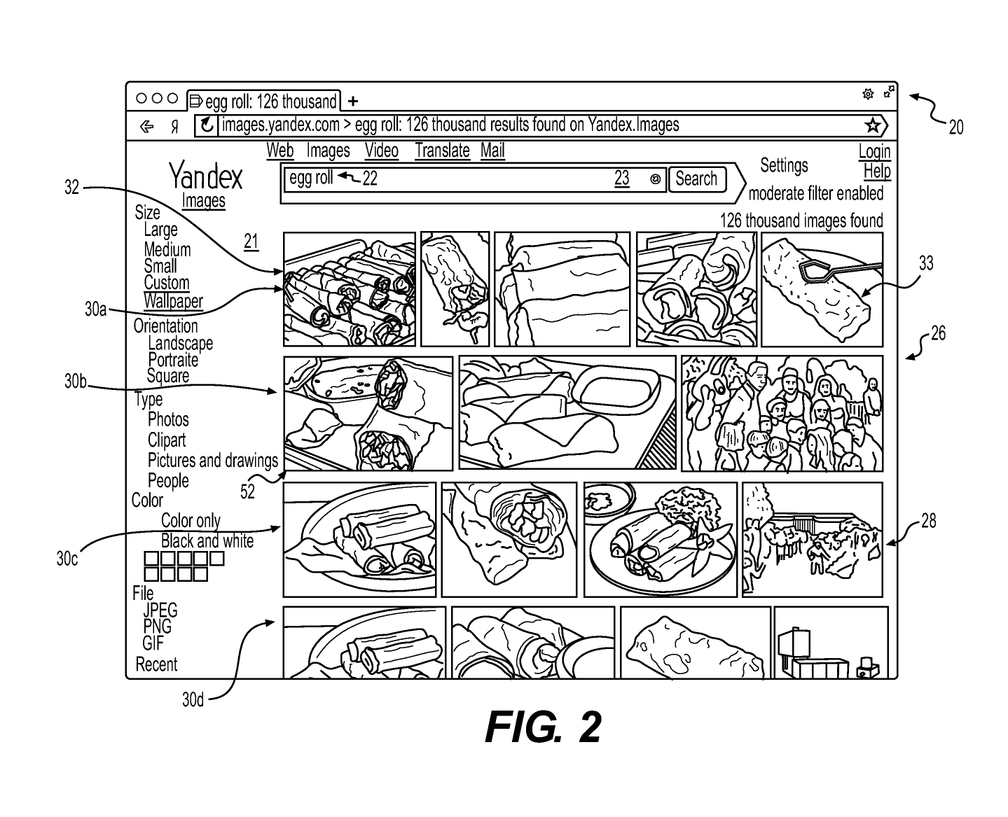

Referring to FIG. 2, there is shown the SERP 21. The display of SERP 21 has been modified from FIG. 1 when the images 26 have been selected by the user by (in this implementation) the user having “clicked” on the images 26 on the unmodified SERP as shown in FIG. 1. In FIG. 2 SERP 21 now no longer shows information regarding webpages, but only the array 28 of the images 26 in thumbnail format having resulted from the search. In this implementation, array 28 includes various rows 30a, 30b, 30c, 30d of images 26, however the images are not grouped into columns. (In other implementations the images could be grouped into columns but not grouped into rows or grouped into both columns and rows.) For purposes of illustration the first (leftmost image) of the top row 30a of the array 28 is given reference 32, the last (the rightmost image) of the top row 30a of the array 29 is given reference 33, and the first image of the second row 30b (from the top) of the array 27 is given reference 52.

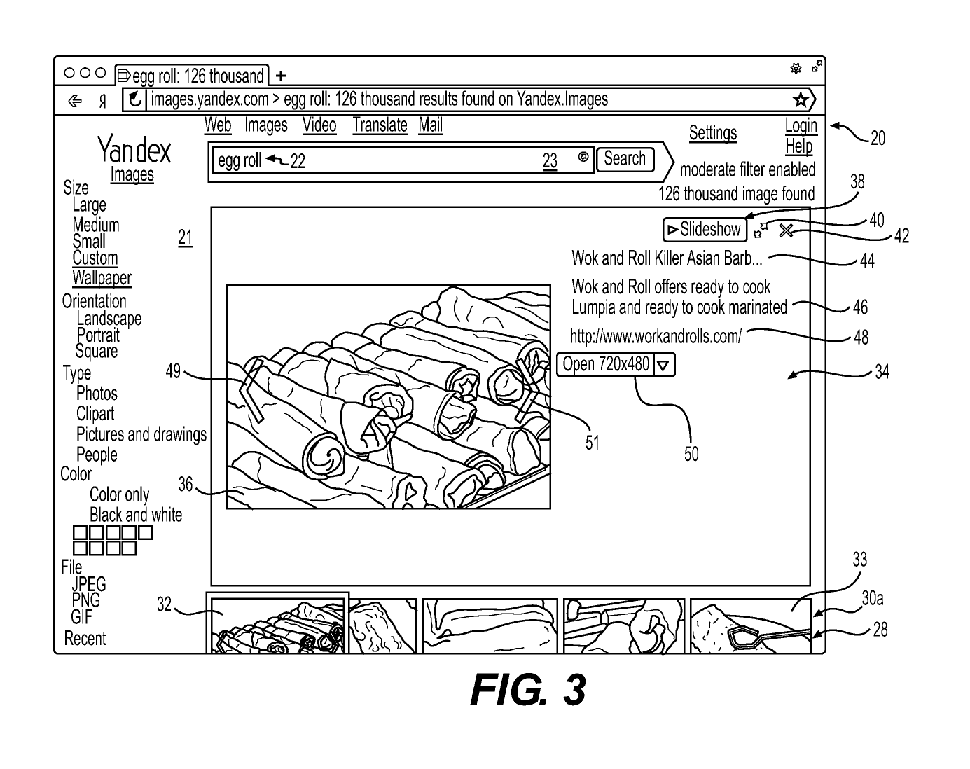

Referring to FIG. 3, there is shown the SERP 21. The display of SERP 21 has been modified from FIG. 2 when the first image 32 of the top row 30a of the array 28 has been selected by the user. In FIG. 3 SERP 21 shows a space 34 above the top row 30a of the array 28. In this implementation space 34 has a colored background, however it should be understood that no particular background of space 34 is required. Shown within space 34 is an expanded version 36 of the user selected first image in thumbnail format 32 of the top row 30a of the array 28. Also shown in space 34 is a slideshow selector element 38, a full screen element 40, a close view element 42, a title of the image 44, a description of the image 46, the URL of the image 48, an image size selector element 50, a show a next image element 51 and a show a previous image element 49. If the user selects the slideshow selector element 38 then the expanded image 36 in the space 34 will be periodically replaced with other ones of the images in thumbnail form in the array 28 without further action by the user. If the user selects the full screen element 40, a further expanded image (of the then current expanded image) shown in the space 34 will be shown in the entire window of web browser 20. If the user selects the close view element 38, the display of the SERP 21 will change such that the space 34 is no longer shown (the SERP will return to appearing as it did in FIG. 2). If the user selects the URL 48 of the image 32/36, the user will be redirected to the Internet resource from on which the image 32/36 is located. If the user selects the imagine size selector element 50 (which in this implementation is a drop-down box), the user would be presented with a number of different image size option from which the user could select. The expanded image 36 would then be resized consequent with the user's selection. If the user selects the show a next image element 51, then the expanded image 36 in the space 34 is replaced with an expanded image of the next image 26 in thumbnail format in the array 28 (in this implementation—the image 26 to right of the current image 32 in the row 30a of the array 28, or if the then current image is the rightmost image in a row of the array then the leftmost image in the next row down of the array). If the user selects the show a previous image element 49, then the expanded image 36 in the space 34 is replaced with an expanded image of the previous image 26 in thumbnail format in the array 28 (in this implementation—the image 26 to left of the current image 32 in the row 30a of the array 28, or if the then current image is the leftmost image in a row of the array then the right image in the previous row up of the array or in the case of image 32, the last row of the array 28). If the user were to select another image 26 in thumbnail format from the array 28 (e.g. the last (rightmost) image 33 is the top row of the array 20a), then expanded image 36 would be replaced with an expanded image of that newly selected image 33. Similarly the image title 44, image text 46, and image URL 48 would be replaced with corresponding info from the newly selected image 33.

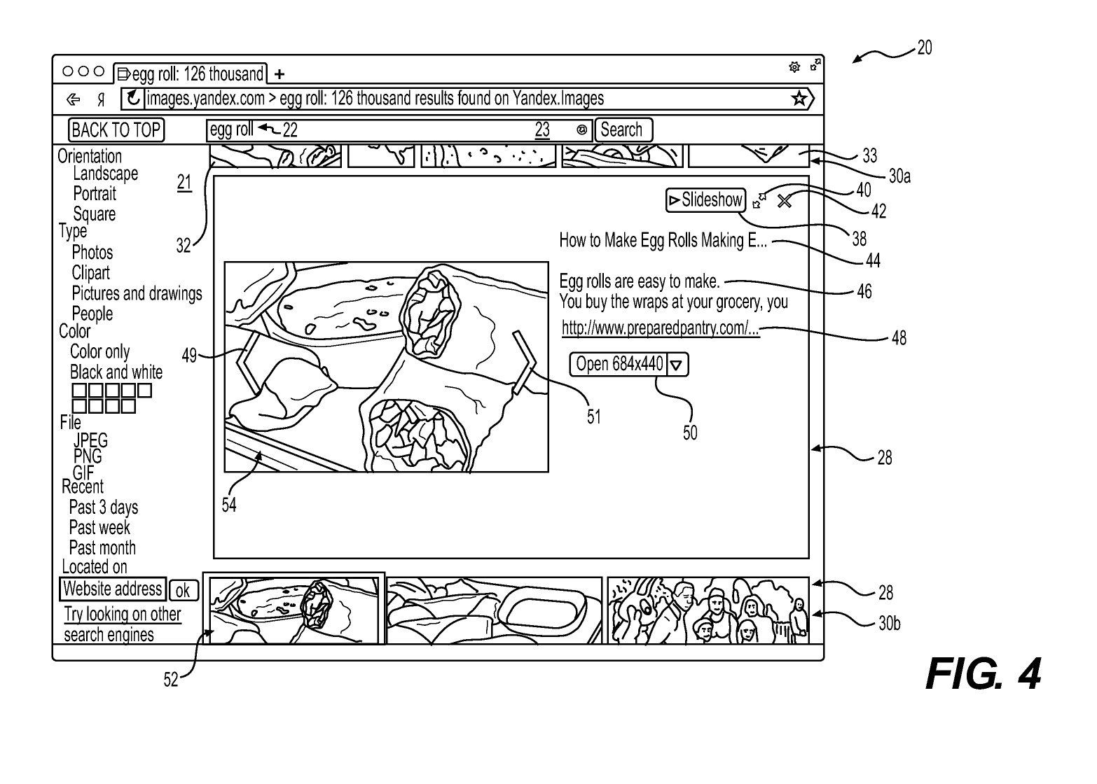

Referring to FIG. 4, there is shown the SERP 21. The display of SERP 21 has been modified from FIG. 2 when the first image 52 of the second row 30b of the array 28 has been selected by the user. In FIG. 4 SERP 21 shows a space 34 below the top row 30a of the array 28 and above the second row 30b of the array 28. Shown within space 34 is an expanded version 54 of the user selected first image in thumbnail format 52 of the second row 30b of the array 28. Also shown in space 34 is a slideshow selector element 38, a full screen element 40, a close view element 42, a title of the image 44, a description of the image 46, the URL of the image 48, an image size selector element 50, a show a next image element 51 and a show a previous image element 49. The actions of these elements are the same as those above and will not be repeated here. If the user were to select another image 26 in thumbnail format from the array 28 (e.g. the last (rightmost) image 33 is the top row of the array 20a0, the expanded image 36 would be replaced with an expanded image of that newly selected image 33. Similarly the image title 44, image text 46, and image URL 48 would be replaced with corresponding info from the newly selected image 33.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

1-10. (canceled)

11. A method of providing image information for display to a user of a client device, comprising:
receiving, by at least one server from the client device via a communications network, a search query;
effecting, by the at least one server, a search in respect of the search query;
sending, by the at least one server to the client device via the communications network, search results, the search results including a plurality of images;
sending, by the at least one server to the client device via the communications network, instructions to cause a display to the user via the user interface of the client device of a search engine results page (SERP) including at least some of the plurality of the images in a thumbnail array; and
sending, by the at least one server to the client device via the communications network, instructions to cause a display of a new row in the array in between existing rows of the imam in the array and a display in the new row of an expanded version of the one of the plurality of images in the thumbnail array having been selected by the user, without leaving the SERP.

12. (canceled)

13. The method of claim 12, wherein the instructions cause no other images to be displayed in the new row.

14. The method of claim 13, wherein the instructions cause at least one selected from a group consisting of an image size selector element, a zoom to full screen element, a show a next image element, a show a previous image element, a slideshow selector element, a title of the image, a description of the image, a link to a website in which the image appears, to be displayed in the new row.

15. A method of providing image information for display to a user of a client device, comprising:
receiving, by at least one server from the client device via a communications network, a search query;
effecting, by the at least one server, a search in respect of the search query;
sending, by the at least one server to the client device via the communications network, search results, the search results including a plurality of images;
sending, by the at least one server to the client device via the communications network, instructions to cause a display to the user via the user interface of the client device of a search engine results page (SERP) including at least some of the plurality of the images in a thumbnail array; and
sending, by the at least one server to the client device via the communications network, instructions to cause a display of a new row in the array adjacent an existing top row of the array and a display in the new row of an expanded version of the one of the plurality of images in the thumbnail array having been selected by the user, without leaving the SERP.

16. The method of claim 15, wherein the instructions cause no other images to be displayed in the new row.

17. The method of claim 16, wherein the instructions cause at least one selected from a group consisting of an image size selector element, a zoom to full screen element, a show a next image element, a show a previous image element, a slideshow selector element, a title of the image, a description of the image, a link to a website in which the image appears, to be displayed in the new row.

18. A method of providing image information for display to a user of a client device, comprising:
receiving, by at least one server from the client device via a communications network, a search query;
effecting, by the at least one server, a search in respect of the search query;
sending, by the at least one server to the client device via the communications network, search results, the search results including a plurality of images;
sending, by the at least one server to the client device via the communications network, instructions to cause a display to the user via the user interface of the client device of a search engine results page (SERP) including at least some of the plurality of the images in a thumbnail array; and
sending, by the at least one server to the client device via the communications network, without leaving the SERP.

19. The method of claim 18, wherein the instructions cause no other images to be displayed in the new row.

20. The method of claim 19, wherein the instructions cause at least one selected from a group consisting of an image size selector element, a zoom to full screen element, a show a next image element, a show a previous image element, a slideshow selector element, a title of the image, a description of the image, a link to a website in which the image appears, to be displayed in the new row.

21-24. (canceled)

25. A system for providing image information for presentation to a user of a client device, comprising at least one server including:
a search query reception component for receiving, by the at least one server from the client device via a communications network, a search query;
a search component for effecting, by the at least one server a search in respect of the search query;
a search results dispatch component for sending, by the at least one server to the client device via the communications network, search results, the search results including a plurality of images;
a search engine results page (SERP) dispatch component for sending, by the at least one server to the client device via the communications network, instructions to cause a display to the user via the user interface of the client device, a SERP including at least some of the plurality of the images in a thumbnail array; and
a SERP display alteration component for sending, by the at least one server to the client device via the communications network, instructions to cause a display of a new row in the array in between existing rows of the images in the array and a display in the new row of an expanded version of the one of the plurality of images in the thumbnail array having been selected by the user, without leaving the SERP.

26-28. (canceled)
